(19) United States
(12) Patent Application Publication
(10) Pub. No.: US 2003/0208433 A1
(43) Pub. Date: Nov. 6, 2003

(54) Bandwidth Trading Engine

(76) Inventors: Paul Haddad, Alpharetta, GA (US); Stephen J. Harris, Ottawa (CA); Miguel A. Planas, Ottawa (CA); Sieghard Maier, Mississauga (CA); Margaret A. Plucinska, Nepean (CA); James H. Buchanan, Ottawa (CA)

Correspondence Address: Gregory Scott Smith, Esq., Troutman Sanders LLP, Docketing Clerk - 46th Floor, 600 Peachtree Street, Suite 5200, Atlanta, GA, 30303, US

(21) Appl. No.: 09/737,278

(22) Filed: Dec. 12, 2000

Related U.S. Application Data
(60) Provisional application No. 60/214,144, filed on Jun. 26, 2000.
(60) Provisional application No. 60/214,096, filed on Jun. 26, 2000.

(51) Int. Cl. G06F 17/60

(52) U.S. Cl. 705/37

(57) ABSTRACT

A system and a method to implement a three sectored business model that facilitates the trading of bandwidth as a commodity. One sector includes resource entities that require or generate the resource or commodity to be traded—bandwidth. Another sector includes bandwidth enabling entities that neutrally provide a pool of bandwidth that can be obtained from a variety of resource entities in a competitive manner. The last sector includes trading companies that interface with resource entities, bandwidth enabling entities, or traders, and facilitate the trading of the bandwidth based on the availability of the bandwidth from one or more bandwidth enabling entities or resource entities. A core engine operates as the central controller and data exchange source for facilitating the execution of trades between and for all entities, provisioning of connections, monitoring of the network, sharing and feedback of data to relative subsystems, and provide data control abilities to subscribing entities.

### RELATED APPLICATIONS

This application is related to U.S. Provisional Application Serial No. 60/214,144, entitled “A BUSINESS MODEL FOR PERFORMING BANDWIDTH TRADING”, filed on Jun. 26, 2000 and U.S. patent application Ser. No. ______, entitled “A BUSINESS MODEL FOR PERFORMING BANDWIDTH TRADING” filed on Nov. ______, 2000. This application claims the benefit of the filing date of U.S. Provisional Application Serial No. 60/214,096 filed on Jun. 26, 2000.

### TECHNICAL FIELD

This invention relates to the field of telecommunications and, more specifically, to a system and method for implementing a bandwidth trading business model so as to enable the trading of bandwidth within a telecommunications system, as a freely traded commodity.

### BACKGROUND

As telecommunication technology continues to develop and allow the establishment of telecommunication systems that are faster, more efficient, and more reliable, a problem that is facing the world is how to dynamically allocate the available bandwidth to maximize the use thereof. In addition, in today's environment, once a carrier establishes connectivity to a site, in essence the carrier obtains a monopoly with respect to that site. This monopoly is established regardless of whether the site is a building, a hub, a point of presence “POP”, or any other form of consumer entity. The monopoly is based on the following scenario. A consumer entity must spend a large amount of money to obtain connectivity to a carrier's facilities. This cost covers activities such as digging and laying cable, extending the cable to the consumer entity, and connecting and integrating the consumer entity into the telecommunications system. Once these tasks have been accomplished, to switch to a more competitive carrier, the consumer entity must again expend considerable cost to obtain connectivity with the more competitive carrier. Once connectivity with the more competitive carrier has been obtained, the consumer entity once again is in the same situation—the more competitive carrier now has a monopoly on the consumer entity's telecommunications business. This is especially true when the consumer entity has signed a long-term contract with the carrier. Thus, there is a need in the art to provide the ability to meet the bandwidth requirements of a person or entity in a competitive manner—in a manner similar to meeting the requirements and needs for other commodities. There is also a need in the art to enable short-term contracts for bandwidth to be obtained by a consumer entity. This need has given rise to the concept of bandwidth trading.

The implementation of bandwidth trading has proven to be a difficult hurdle to clear. There are three basic entities, or classes of entities, involved in the bandwidth trading business: trading entities, buyers and sellers of physical resources (resource entities), and exchange or minute selling entities. There is a vast amount of confusion in the market place on how these entities plan on conducting business. Trading entities have traditionally traded commodities on public exchanges or over the counter. These commodities include items such as pork bellies, tobacco, coffee, crude oil, or the like. Trading entities have been trading such commodities for years and are very familiar with the procedures necessary to successfully trade such commodities. In addressing the bandwidth trading aspect of the business, some trading entities plan on building their own networks to create the bandwidth commodity, and then trade the commodity they have just created. However, the traditional trading entities have little to no experience in the world of telecommunications, yet alone, bandwidth trading. Therefore, the anticipated success of this approach is, at the very most, skeptical. In order to ensure a successful bandwidth trading industry, it is necessary to efficiently perform the following tasks:

(a) locate bandwidth to be traded;

(b) exchange related data;

(c) accept a request for a bandwidth trade;

(d) execute the trade and deliver or physically connect the traded band;

(e) manage the traded bandwidth;

(f) provide customer service in support of the traded bandwidth; and

(g) ensure financial clearance among all participants.

The resource entities include but are not necessarily limited to carrier companies and/or service providers. Today, some resource entities are planning on simply trading the commodity of bandwidth that they are currently creating and operating. However, although these resource entities are very aware of the telecommunications business, they are just beginning to learn the complexities of the operation and procedures of the commodities trading business. Thus, it may be difficult for the resource entities to setup and operate a successful trading system.

The exchange entities are stuck in the middle of both confusions. Today, the exchange entities primarily focus on selling minutes. Selling minutes is a substantially different concept from trading bandwidth. Thus, there is a need in the art for a method to trade bandwidth as a commodity, that enables each of the participants to operate in their most optimal fashion, and provides a reasonable solution for trading bandwidth.

There are some companies that are currently attempting to operate in all three of the above-described classes by trading, selling minutes and owning networks. This type of approach will operate to stifle the emergence of true bandwidth trading and will result, in reality, to simply implement the above-described monopoly model.

Thus, there is a need in the art for a business model that will efficiently allow for bandwidth trading. The business model must facilitate the creation of a true bandwidth trading industry within a neutral and flexible environment. Companies adopting such a business model will most typically operate as one of the above-described classes of entities. The business model allows the adopting entities to deal with other entities, establish business deals, and transact over each other's sites or facilities.

The related U.S. Provisional Application Serial No. 60/214,144, discloses a bandwidth trading business model. The contents of this related Application are herein incorporated by reference; however, a brief description of the bandwidth trading business model is included for reference.

The bandwidth trading business model identifies a business structure under which bandwidth can be traded as a commodity. Generally described, the business model defines three business sectors: resource entities, bandwidth enabling entities, and trading entities. The resource entities create the bandwidth commodity. The bandwidth enabling entities operate as neutral parties and obtain connectivity to the facilities of one or more resource entities. The trading entities serve as an interface to a consumer entity or trader and allow for the purchase, selling, reselling or otherwise trading of the bandwidth commodity. Thus, utilizing the business model, bandwidth can be freely traded as a commodity.

More specifically, the bandwidth trading business model enables a consumer entity or a trader, to trade a certain amount of bandwidth between two end points and that is associated with a specific period of time. An end point may be any of a variety of elements including, but not limited to, a private branch exchange, a hub, a point of presence “POP”, a central office switch, a pooling point, or any other of a variety of system or consumer elements. The traded bandwidth is a real quantity of bandwidth that may be utilized to communicate between two end points of a telecommunications system during the specific time period. The bandwidth enabling entities establish multiple pooling points that are interconnected with end points within a telecommunications network. A pooling point is an element that operates to provide connectivity between (a) one or more endpoints and the facilities of one or more resource entities, (b) one or more pooling points and the facilities of one or more resource entities or end points, or (c) multiple resource entities. Thus, the pooling points interface with the facilities provided by resource entities, each of the resource entities providing bandwidth capacity between pairs of the pooling points and/or between end points and pooling points. The resource entities may include companies that provide world wide or nation wide networks, as well as smaller, more local telecommunication networks. The bandwidth enabling entities negotiate and enter into agreements with the resource entities, as well as trading companies. These agreements relate to the provision and cost of the bandwidth capacity between pooling points and between pooling points and end points. A trading entity provides an interface to the consumer entity or trader whereby the consumer entity may request a trade of a certain amount of bandwidth capacity between two end points, an end point and a pooling point, or two pooling points.

In operation, a trader approaches a trading entity with a request to trade a specific bandwidth commodity. This trade may encompass a specific quality of service, time frame, data rate, or the like. In response to such request, the trading entity executes the trade either over a specific bandwidth enabling entity's pooling point or over the pooling points of one or more bandwidth enabling entities, or over the resource entities network directly. The underlying operations of the trading entity are transparent to the trader. As an example, a trader may request a purchase of a particular amount of bandwidth to be active at a particular time for a particular duration. The trader does not need to be aware of who is providing or obtaining the bandwidth or what other entities are involved in the trade. All that the trader is concerned about is (a) obtaining the desired bandwidth for the desired price and quality of service, and (b) if the trader's intention is to actually utilize the bandwidth, then at the requested time, the connections are established to provide connectivity with the requested bandwidth capacity. The reader should understand that as a commodity, the trader may have no intention of actually utilizing the traded bandwidth. Thus, if the trader so chooses, the bandwidth capacity, or any unused portion there of may be traded through a trading entity prior to the total consumption of the bandwidth. In addition, the trader may sub-divide the bandwidth and trade each portion of the divided bandwidth separately.

The complexities associated with an implementation of such a business model are quite enormous. The amount of data that must be exchanged, the physical activities of providing connectivity, maintaining current status regarding the resources of each entity involved, monitoring the connection, terminating the connect, as well as a host of other issues add to these complexities. Thus, there is a need in the art for a system and a method for implementing a bandwidth trading business model.

An implementation of the above-described bandwidth trading model should enable the neutrality goals of the business model. Thus, the implementation must freely allow the exchange of bandwidth, in a competitive market, without giving deference to certain entities involved in the process.

### SUMMARY OF THE INVENTION

The present invention solves the above-described problems by providing a bandwidth trading engine that facilitates the trading of bandwidth, the provisioning of connections, and any other functions necessary to execute the trade. Thus, the present invention ensures a successful bandwidth trading industry, by efficiently performing the tasks of:

(a) locating bandwidth to be traded;

(b) exchanging related data;

(c) accepting a request for a bandwidth trade;

(d) executing the trade and delivering or physically connecting the traded band;

(e) managing the traded bandwidth;

(f) providing customer service in support of the traded bandwidth; and

(g) ensuring financial clearance among all participants.

More specifically, the present invention includes a system for enabling bandwidth-trading among a plurality of entities. The system includes a seller interface, a buyer interface, a database and a processing unit. The processing unit is operative to receive data representing multiple bandwidth-commodities from one or more bandwidth selling entities by means of the seller interface. For each bandwidth-commodity, at a minimum, the data identifies a bandwidth capacity, two end points, and a period of time. The data may also include the quality of service requirements and pricing information. The processing unit then stores the data into the database. Upon receiving a bandwidth purchase request via the buyer interface, the bandwidth purchase request identifying a desired bandwidth capacity between a first end point and a second end point for a desired time period and being received from a bandwidth buying entity by means of the buyer interface, the processing unit searches the database to identify a compatible bandwidth-commodity that meets the desired bandwidth capacity between the first end point and the second end point for the desired time period. If the processing unit identifies a compatible bandwidth-commodity, the processing unit will execute a trade in which the ownership of the compatible bandwidth-commodity is transferred to the bandwidth buying entity. In addition, the processing unit will facilitate the exchange of related data between the parties involved in the transaction.

In one embodiment, the bandwidth trading system includes a provisioning interface. In this embodiment, prior to the commencement of the desired time period, the processing unit is operative to send provisioning information via the provisioning interface to the facilities associated the compatible bandwidth-commodity. The provisioning information is effective, when received by the facilities, to instruct the facilities to connect the first end point and the second end point in accordance with the compatible bandwidth-commodity.

Another embodiment of the bandwidth trading system includes a monitoring interface. In this embodiment, during the desired time period, the processing unit monitors the connection between the first end point and the second end point and provide relative visibility to involved parties. Thus, through the monitoring interface, a management function of the traded bandwidth can be performed. In addition, this aspect of the present invention facilitates the provision of customer service in support of the traded bandwidth.

In yet another embodiment of the bandwidth trading system, the data representing a bandwidth-commodity includes pricing information. In addition, the bandwidth purchase request includes a desired price. In this embodiment, the processing unit searches the database to identify a compatible bandwidth-commodity by identifying a compatible bandwidth-commodity that satisfies the desired price requirements. In addition, this embodiment may include a billing interface. In this embodiment, prior to executing the trade, the processing unit receives billing information from the bandwidth buying entity by means of the buying interface and, executes the trade by sending the billing information over the billing interface to a billing entity.

These and other aspects, feature, and advantages of the present invention will be more clearly understood and appreciated from a review of the following detailed description of the present invention and possible embodiments thereof, and by reference to the appended drawings and claims.

### BRIEF DESCRIPTION OF THE DRAWINGS

FIG. 1 is a system diagram that illustrates an exemplary environment suitable for implementing various embodiments of the present invention.

FIG. 2 is a conceptual diagram of an exemplary embodiment of the bandwidth trading business model of the present invention.

FIG. 3 is a functional diagram illustrating the role of the core engine of the bandwidth trading engine in implementing the bandwidth trading business model.

FIG. 4 is a simplified functional diagram illustrating the role or the core engine and the entities involved in a single bandwidth trade transaction.

FIG. 5 is a system diagram illustrating components required to implement a limited, non-neutral bandwidth trading system.

FIG. 6 is a system diagram illustrating the operation of the bandwidth trading engine within a telecommunications network system.

FIG. 7 is a flow diagram illustrating the operation of an exemplary embodiment of the present invention in the performance of a bandwidth commodity trade.

### DETAILED DESCRIPTION OF THE INVENTION

The present invention identifies a business model to facilitate bandwidth trading within the telecommunications industry. Based on the business models in existence today, the long-run financial viability of these business models, and the market sizes and technologies associated with bandwidth resources, the most profitable and efficient model to implement bandwidth trading is to divide the market into three sectors and confine the operation of entities within one of these three sectors. The three sectors include resource entities, bandwidth enabling entities, and bandwidth trading entities.

The carriers are the natural resource owners and producers of the bandwidth commodity. In the realm of bandwidth trading, the natural resource to be traded is the networks or, more specifically, the bandwidth availability of the network. Every transmission medium can be defined by the amount of bandwidth that can be passed through the medium. Bandwidth is the measure of how much information can pass through the medium. The bandwidth of a particular transmission medium can often times be subdivided and utilized among various entities. Those skilled in the art will understand that bandwidth within a transmission medium can be divided using a variety of techniques such as frequency translation, time division multiplexing, code division multiplexing, channelization, or the like. Regardless of the technique used, measurable amounts of bandwidth of a transmission medium can be allocated and reserved for a particular entity. Thus, for purposes of this application, the term bandwidth is used to broadly refer to any measurable allocation of capacity on any type of traffic carrying medium.

The bandwidth enabling entities operate as the pipeline and shipping player within the bandwidth trading business model. The enabling entities (a) establish, own, and/or operate pooling points which operate to connect the facilities of consumer entities to the network facilities of a resource entity at the physical level and (b) make or facilitate the trade or exchange of bandwidth.

The bandwidth trading entities are the pure traders within the business model. The bandwidth trading entities operate by taking position, hedging risks, managing the commodity, or the like—operations typical to most commodity trading companies. The business model of the present invention allows for flexible and generic bandwidth trading. Through an adaptation of this business model, any trading entity can trade on any pooling point, where capacity and bandwidth are available, without regard to which carrier owns or operates the network.

As an example, trading entity A may sign a deal with bandwidth enabling entity B to trade bandwidth over bandwidth enabling entity B's pooling points in New York, Los Angeles, and Atlanta. Additionally, bandwidth enabling entity B may sign a deal with resource entities C and D whereby resource entities C and D connect their networks to the pooling sites of bandwidth enabling entity B located in New York and Los Angeles. Company B also may also sign a deal with resource entities C and E whereby resource entities C and E are connect their networks to the pooling site of bandwidth enabling entity B located in Atlanta. Thus, any party at the trading entity A is able to work with a variety of bandwidth enabling companies who, in turn can each work with a variety of carrier companies. Furthermore, trading entity A can trade directly over resource entity C's, D's or E's networks if trading entity A has a business relationship with such resource entities and can physically connect to their networks. Thus, neutrality is preserved among all the participants—a business model that directly contrasts with the monopolistic model that exist today.

Exemplary Operating Environment

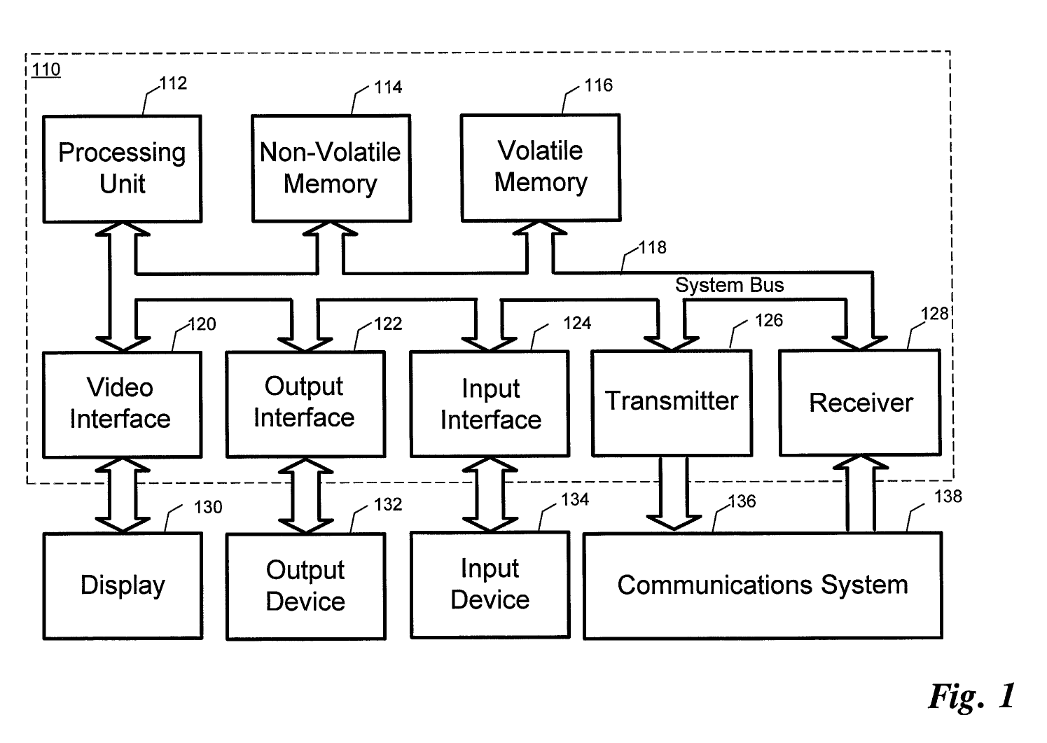

FIG. 1 is a system diagram that illustrates an exemplary environment suitable for implementing various embodiments of the present invention. FIG. 1 and the following discussion provide a general overview of a platform onto which components, aspects, or the entire invention may be integrated or implemented. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Examples of such forms and functions include server systems, web servers, stand-alone computer systems, work stations, note-book computers, lap-top computers, and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 114 provides storage for power on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may send output information, in addition to the display 130, to one or more output devices 132 such as a speaker, modem, printer, plotter, facsimile machine, RF or infrared transmitter, computer or any other of a variety of devices that can be controlled by the computing device 110. The processing unit 112 interfaces to each output device 132 through an output interface 122 coupled to the processing unit 112 over the system bus 118. The output interface may include one or more of a variety of interfaces, including but not limited to, an RS-232 serial port interface or other serial port interface, a parallel port interface, a universal serial bus (USB), an optical interface such as infrared or IrDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface may include one or more of a variety of interfaces, including but not limited to, an RS-232 serial port interface or other serial port interface, a parallel port interface, a universal serial bus (USB), an optical interface such as infrared or IrDA, an RF or wireless interface such as Bluetooth, or other interface.

It will be appreciated that program modules implementing various embodiments of the present invention may be may be stored in the non-volatile memory 114, the volatile memory 116, or in a remote memory storage device accessible through the output interface 122 and the input interface 124. The program modules may include an operating system, application programs, other program modules, and program data. The processing unit 112 may access various portions of the program modules in response to the various instructions contained therein, as well as under the direction of events occurring or being received over the input interface 124.

The computing device 110 may transmit signals to, or receive signals from, one or more communications systems 136 such as a cellular network, RF network, computer network, cable network, optical network or the like. The processing unit 112 interfaces to each communications system 136 through a transmitter 126 and a receiver 128, both coupled to the processing unit 112 over the system bus 118. The transmitter 126 and the receiver 128 may include one or more of a variety of transmission techniques such as a radio frequency interface (AM, FM, PSK, QPSK, TDMA, CDMA, Bluetooth or other technique) or an optical interface such as infrared or IrDA.

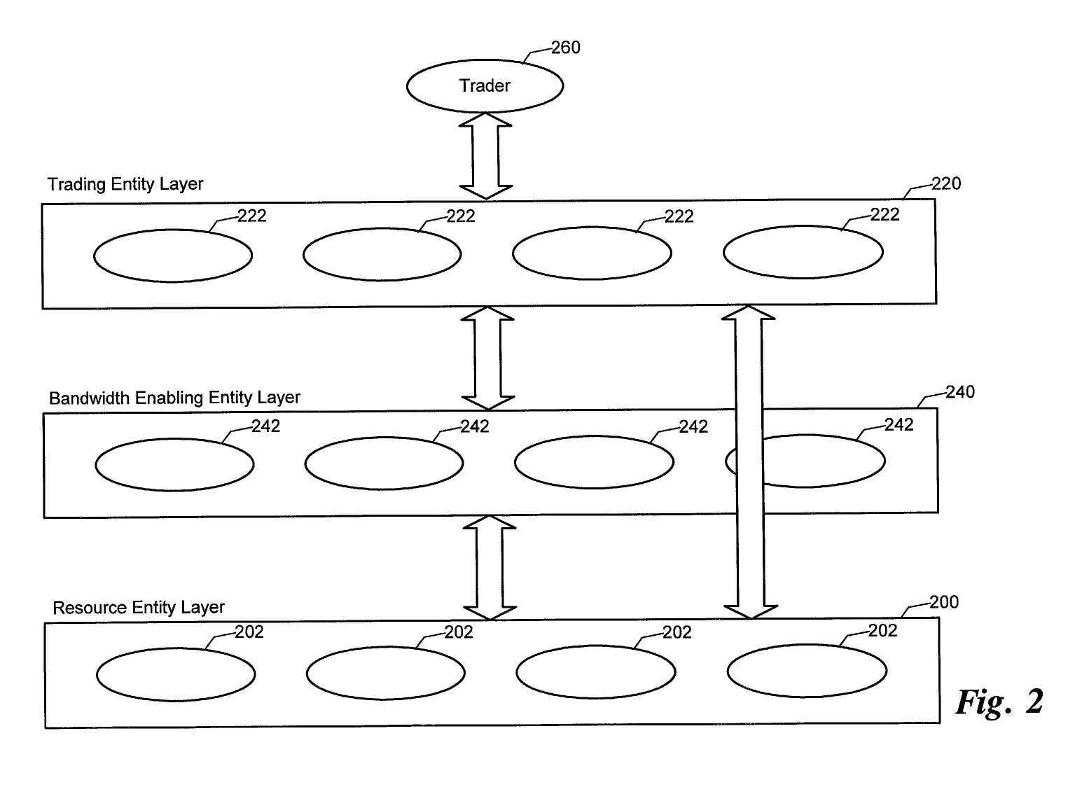

FIG. 2 is a conceptual diagram of an exemplary embodiment of the bandwidth trading business model of the present invention. The relationship between each of the three sectors is shown as three layers within the business model. Each of the entities operating in a layer performs a substantially different task than the entities in the other layers. The lower layer is the bandwidth seller or the resource entity layer 200. The resource entity layer includes one or more resource entities 202 that operate within the carrier layer 200 of the business model. The resource entities 202 build, own and operate telecommunications networks—the source of the bandwidth commodity—but may actually be any of a variety of entities that sell bandwidth. As previously described, the resource entities 202 may own and operate world wide, national, or localized networks. The networks may be traditional, fiber optic, cable, a hybrid of fiber optic and cable “HFC”, wireless, satellite, or any of a variety of other network types. The upper layer is the bandwidth trading entity layer 220. Traditional trading entities 222 reside at this layer of the business model. The typical trading entities 222 that currently trade energy, utilities, or other commodities, will assume the role of trading bandwidth as an additional commodity within their portfolio of commodities. In addition, some trading companies may be totally dedicated to trading bandwidth. The middle layer is the bandwidth enabling entity layer 240. Bandwidth enabling entities 242 reside at this layer of the business model. The key aspect of the bandwidth enabling entities 242 is the maintenance of neutrality. Neutrality of the bandwidth enabling entities 242 enables the free trading of the bandwidth in a competitive, non-monopolistic fashion. The structure and operation of the business model of the present invention uniquely establishes the ability for neutrality.

In operation, the resource entities 202 produce the bandwidth commodity. The resource entities are familiar with telecommunications technology and communication networks and, to be successful, it is necessary for the resource entities to be experts in providing reliably, easily accessible, credible, robust and cost effective services. Thus, as a source for bandwidth commodity, the resource entities are particularly well suited.

The bandwidth enabling entities 242 perform several functions within the business model. One such function is building or establishing pooling points and negotiating business agreements with various resource entities 202 under which the resource entities 202 connect to the pooling points. The business agreements identify a price, or a pricing structure, at which the bandwidth enabling entities 242 can obtain the bandwidth from the resource entities. Another function of the bandwidth enabling entities 242 is to provide connectivity to the facilities of a resource entity 202, another pooling point, or an end point.

The trading entities 222, serve as the interface and enabling agent for the consumer entity or trader 260 to trade bandwidth. A trader 260 will approach a trading entity 222 with a request to trade a portion of bandwidth. Based on the bandwidth availability across various pooling points, the business relationship between the trading company 222 and the bandwidth enabling entity 242, the trading entity 222 can execute the requested trade. The executed trade can be in the form of a commit or an open trade. In a commit trade, the bandwidth enabling entities 242 will allocate the traded bandwidth and reserve the resources necessary to provide the bandwidth. For an open trade, the bandwidth enabling companies 242 do not commit resources under the expectation that the bandwidth will again be traded prior to the time that the bandwidth is to be consumed.

Thus, the business model illustrated in FIG. 2 allows a trader 260 to approach one or more trading entities 222 to fulfill a trade. If the trader 260 elects a particular trading entity 222, the trader will still have the benefit of the trading company dealing with multiple bandwidth enabling entities, which in turn may deal with multiple resource entities 202. This business model advantageously enables the trader 260 to trade bandwidth in a competitive and neutral manner.

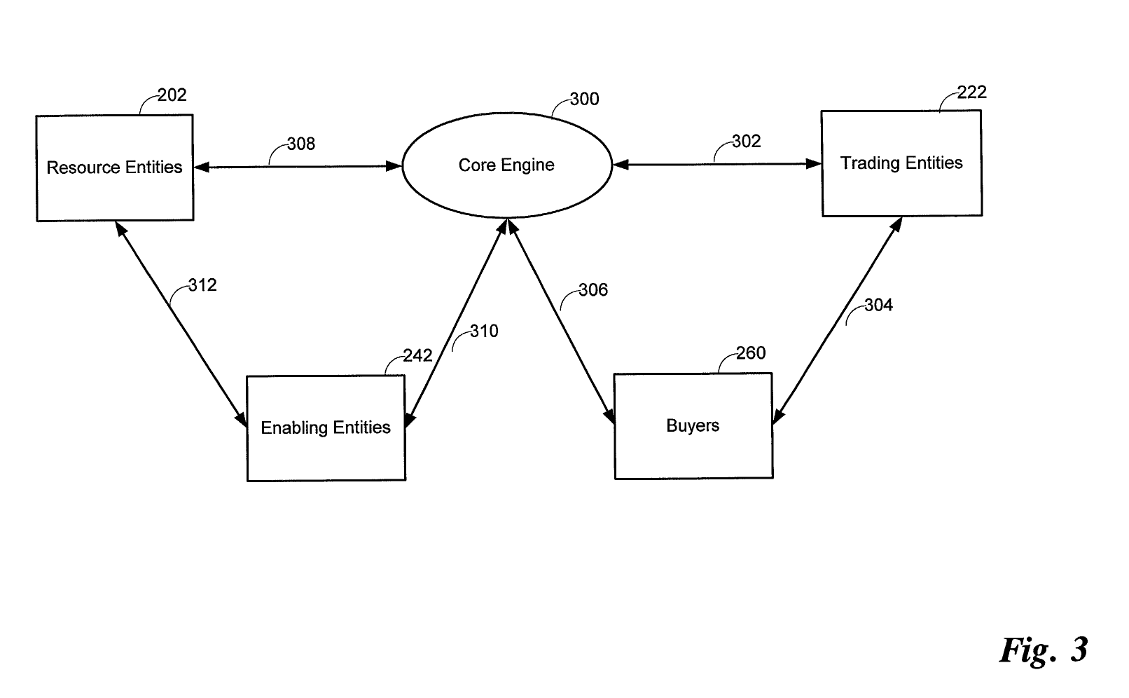

FIG. 3 is a functional diagram illustrating the role of the core engine of the bandwidth trading engine in implementing the bandwidth trading business model. The core engine 300 of the bandwidth trading engine operates as the central controller of the bandwidth trading engine. The core engine 300 interfaces to and facilitates the exchange of information between each of the other entities within the bandwidth trading business model. The trading entities 222 have an interface 302 to the core engine 300 to examine availability of bandwidth commodities, monitor the operation and volatility of the bandwidth commodity market, initiate and execute bandwidth commodity trades, obtain research information for buyers or traders 260, and the like. A buyer 260 desiring to purchase a bandwidth commodity may approach a trading entity 222 either directly 304 or through an interface 306 to the core engine 300. In addition, the buyer 260 may also bypass the trading entity 222 completely and initiate or execute a trade independent of the trading entity 222.

The carriers or bandwidth selling entities 202 have an interface 308 to the core engine. The core engine 300 receives data from the resource entities and is populated based on the resource entities' decision for selling bandwidth. The core engine 300 is fully tailored for a resource entity's environment. The data that the core engine 300 receives from each resource entity will enable the other players or entities within the system, at the permission of the individual resource entity, to see the information related to the resource entity's networks and transact accordingly. Part of the core engine's requirements for the resource entities include: bulk provisioning, connection editing, scheduling, connection completion, offering interfaces and security. The data stored by the core engine 300 pertaining to the resource entities includes, but is not limited to:

the type of bandwidth and traffic available from the resource entity;

the pricing information including sale price, minimum bid, auction offering for a particular bandwidth commodity;

the service level agreements and quality of service, capacity, and availability of a particular bandwidth commodity;

whether or not certain bandwidth commodities are sellable;

the activation date and time for a particular bandwidth commodity;

the availability dates for a bandwidth commodity;

the withdrawal or deactivation date and time for a particular bandwidth commodity;

the contract periods over which the resource entity is selling bandwidth commodities (months, weeks, days);

whether a bandwidth commodity is provisioned or not;

the pooling points supported or connected to the resource entity's facilities or a particular bandwidth commodity;

the bandwidth commodities that are available for being swapped for other bandwidth commodities;

the current owner of a bandwidth commodity;

the status of a connection including alarm information for connection errors; and

the entity to receive bandwidth commodity upon expiration of a current agreement.

Those skilled in the art will appreciate that additional information may also be defined and provided to the core engine from each of the resource entities and that the above-listed information is intended in all respects to be illustrative rather than restrictive.

The enabling entities 242 have an interface 310 to the core engine 300. The core engine 300 receives data from the enabling entities and is populated based on the enabling entities' decision for allowing bandwidth to be traded. The core engine 300 is fully customizable for an enabling entity's environment. The data that the core engine 300 receives from each enabling entity 242 will enable the other players or entities within the system, at the permission of the individual enabling entity, to see the information related to their pooling points availability, available bandwidth capacity, and to execute transactions. The data received and stored by the core engine 300 pertaining to the enabling entities 242 includes, but is not limited to:

a real-time inventory of the bandwidth commodities including bandwidth type and traffic type and time sensitive inventory information;

the source or the seller of a particular commodity;

the buyer of a particular commodity;

all types of connection data and information;

service level agreement and protection state of a commodity;

the parameters of a current contract including starting and ending dates, bandwidth capacity, penalties, owner or buyer, effective throughput, reliability and quality of service, price, end points involved, etc.;

the provisioning information for the pooling points;

the cities, or active pooling points and exchange capacity;

suppliers of services and commodities;

routing information between the enabling entities pooling points and other points within the network, including hops, capacity, and the like;

the location and capacities of the pooling points of the enabling entity;

the schedule for activation and deactivation of particular bandwidth commodities;

a time map illustrating availability and non-availability of commodities for an enabling entity;

the status information of a provisioned commodity;

the delivery customer;

the original offering price of a commodity, the aggregation of paths, and validation status;

information transfer for fault date performance (clearing house);

support provided for commodity swapping;

whether any commodities are currently free and available for trading;

security information;

secure data partition; and

registration information of sellers and buyers (traders).

The enabling entities 242 also have a direct interface 312 to the resource entities through which similar data can be obtained, traded, or shared, and provisioning services can be provided or enabled.

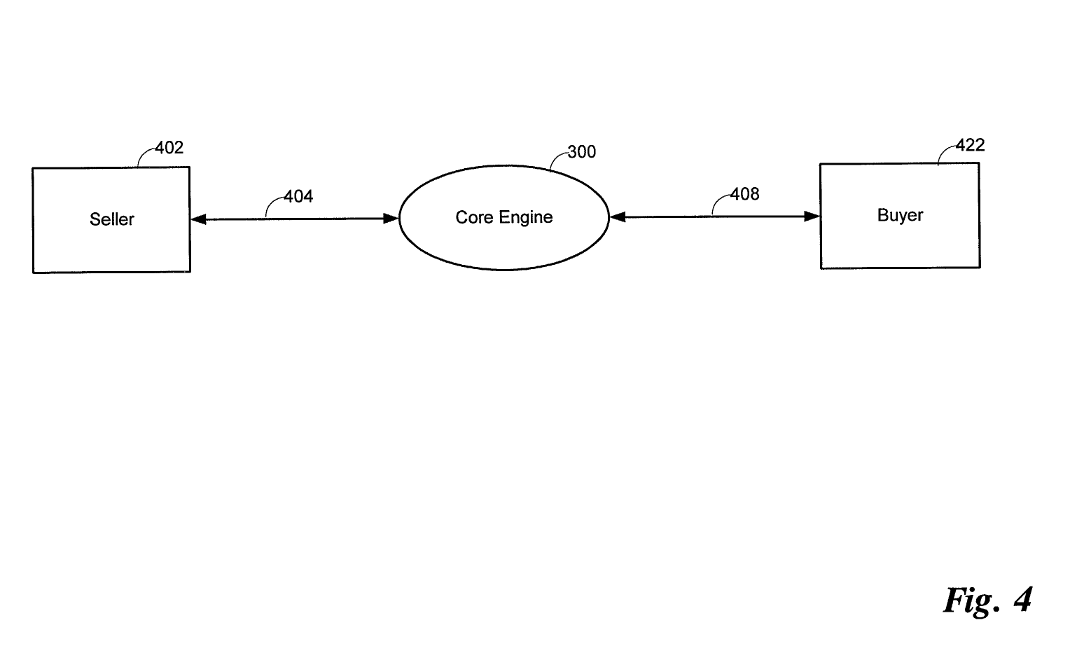

Those skilled in the art will realize that the functional diagram of FIG. 3 can be simplified to illustrate the relationship of the core engine 300 in operation with two entities, a buyer and a seller. FIG. 4 is a simplified functional diagram illustrating the role or the core engine and the entities involved in a single bandwidth trade transaction. A trade is simply a transaction between two entities, a buyer 422 and a seller 402. In some instances, such as in a swap, both entities operate as a buyer and a seller. In simplifying the operation of the present invention, the various entities may take on various roles depending on the characteristics of a particular transaction. For instance, a trading entity 222 may operate as a buyer or a seller depending on the requested transaction. In addition, a resource entity 202 may operate as a seller when off loading bandwidth and a buyer when acquiring its own bandwidth back or when acquiring new and additional bandwidth from other resource entities 202. An enabling entity 142 or a trader 160 may operate as a trading entity 222 and take a position on a particular bandwidth commodity (operating as a buyer) and then sell its position at a more favorable time (operating as a seller). Thus, the functional diagram of FIG. 4 illustrates the basic operation of the core engine 300—to facilitate bandwidth trading amongst a variety of entities operating in a variety of roles.

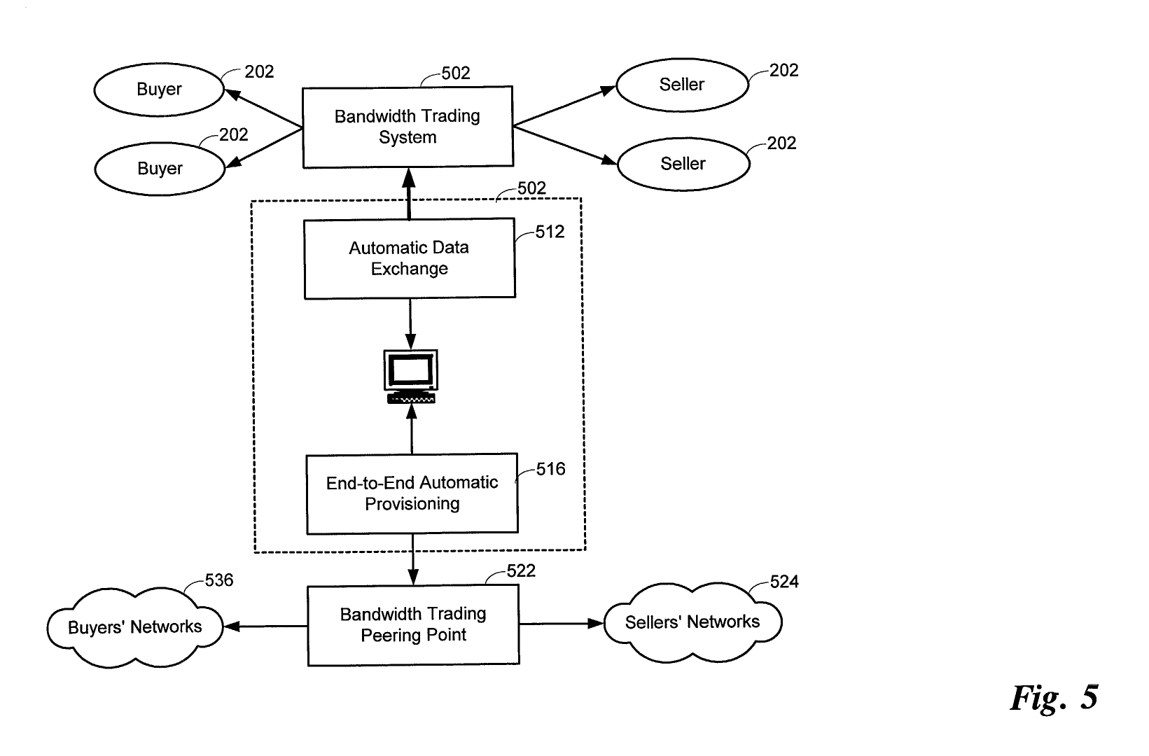

FIG. 5 is a system diagram illustrating components required to implement a limited, non-neutral bandwidth trading system. The illustrated system includes a bandwidth trading system 502 and network management system 504. The network management system 504 in this embodiment operates to perform an automatic data exchange function 512 and an end to end provisioning function 516. The automatic data exchange function 506 obtains information from the buying and selling entities through the trading system 502 and maintains information regarding the bandwidth trading peering point 522 and the connections to the sellers' networks 524 and the buyers' networks 526. The automatic data exchange function 506 also provides data to the bandwidth trading system 502. The end to end provisioning function 516 operates to connect or disconnect resources in response to buyer and seller activity. The short coming of this system is that it only services a single enabling entity 242. Each enabling entity 242 within a telecommunications system would require a similar setup. This system structure does not provide neutrality in trading due to the fact that buyer and sellers must operate through a single enabling entity 242.

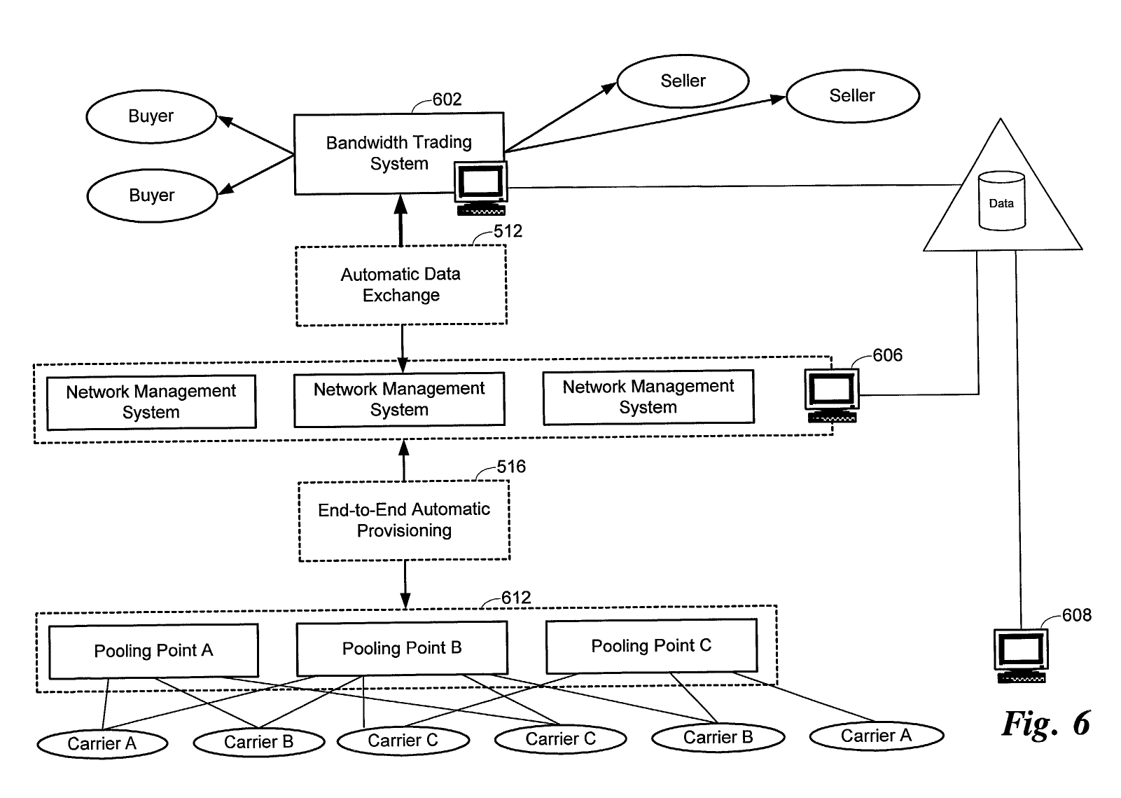

FIG. 6 is a system diagram illustrating the operation of the bandwidth trading engine within a telecommunications network system. The functional components illustrated in FIG. 5 are shown again in FIG. 6 only for clarification purposes and to demonstrate the existence of certain functions. The core engine 300 in FIG. 6 interfaces to the bandwidth trading system 602, the network management systems 606 of multiple enabling entities, and a system controller 608 for the facilities of the resource entities. Thus, the core engine 300 provides the automatic data exchange function between the bandwidth trading system 602 and the various network management systems 606. Additionally, as described in conjunction with FIG. 3, the core engine 300 also facilitates the exchange of data between other entities including the carrier systems 608 and virtually any entity with an enabled system that can interface to the core engine 300. In one embodiment, the interface to the core engine 300 is an open system interface such as Java, TCP/IP, Corba or other open interfaces. This embodiment advantageously also allows for the interface of other systems such as a monitoring interface, a billing interface, a provisioning interface, or other similar interfaces. The monitoring interface allows an independent system to communicatively connect to the core engine 300 and monitor the operation of the telecommunications network, the current status, the availability of bandwidth, or the like. The billing interface allows the core engine 300 to interact with billing entities to complete full transactions including withdrawing funds from a purchasers bank account, billing credit card numbers, etc. The provisioning interface allows external entities, or the core engine 300 to control the provisioning or the connection of end points within the network based on ownership of bandwidth commodities.

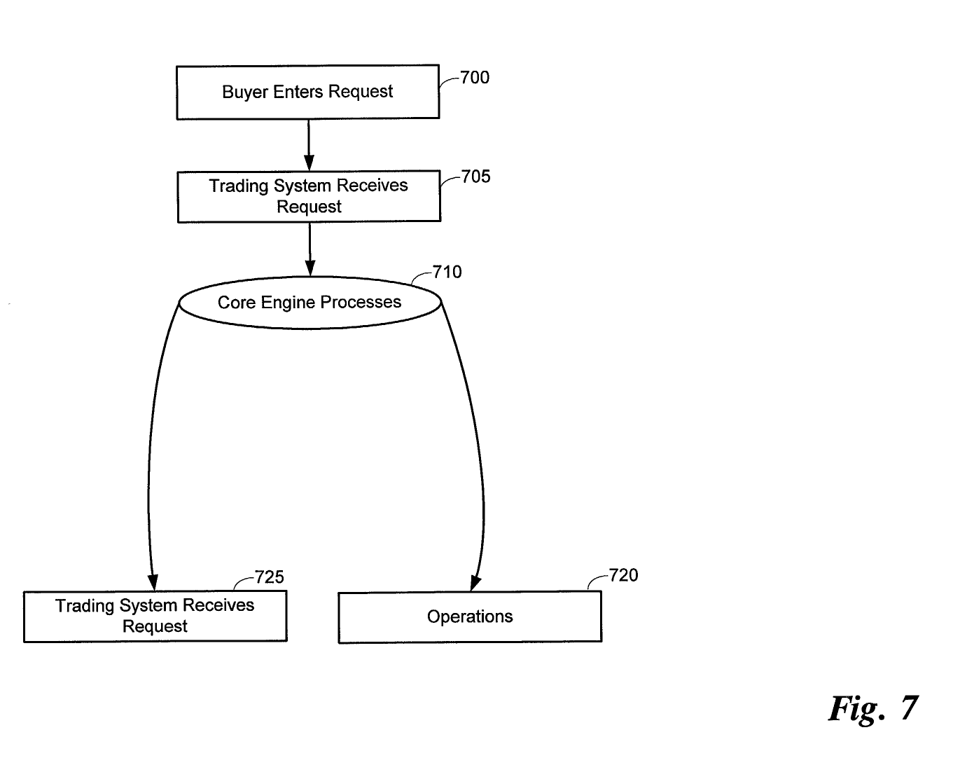

FIG. 7 is a flow diagram illustrating the operation of an exemplary embodiment of the present invention in the performance of a bandwidth commodity trade. Initially, a buyer submits a request for a commodity trade, such as a purchase 700. The buyer can submit the trade through a web enabled device that is connected to the core engine 300, or to a trading company by the same means, or through any other communications medium. If the latter technique is utilized, the trade request is received by the trading system 705.

In furtherance of executing the requested trade, the trading system interfaces with the core engine 710. The trading system polls the core engine to identify available commodities that may satisfy the request from the buyer. The trading system access information such as the availability and lead time for connecting various bandwidth commodities, routes, pricing, quality of service, carrier source, duration of availability for a given commodity, inventory of available commodities, etc. Once the trading system identifies an available bandwidth commodity that meets the requirements of the buyers trade request, the trading system initiates the execution of the transaction. The core engine then either performs a commit to initiate the provisioning of a connection for the bandwidth commodity or obtains the necessary information to allow the responsible enabling entity or the trading entity to initiate the provisioning at a later date.

If connectivity is established, a data exchange event occurs whereby the core engine can notify each of the other entities, either passively or actively, that the resources have been committed. In certain embodiments, the core engine can also interface with a billing entity to invoke a monetary transfer to cover the trade. At the conclusion of the transaction, the core engine provides feed back information to the buyer, the trading system, and any other entity involved in the transaction 725. In addition, the core engine may invoke various operations 720. These operations may include monitoring, or providing performance monitoring to identify the throughput of the connection, detect alarms or problems with the connection, monitor quality of service, or the like. The core engine may also monitor the date and time and then automatically disconnect the connection upon the expiration of the contract and then flag the availability of the commodity for repurchasing. The core engine may also provide warning information or feedback to indicate that the contract is approaching the end and allow the owner the opportunity to extend the contract rather than having to again engage the trading process.

The bandwidth trading engine of the present invention enables much flexibility in the trading of bandwidth as a commodity. For instance, a trading company can buy bulk amounts of bandwidth based on a relationship with an enabling company or a carrier at a bargain price and sleep on the contracts. Since the core engine can select between commit or non-commit purchases, the trading company can hold these contracts until a subsequent purchaser makes them an acceptable offer, as long as the offer is prior to the expiration of the bandwidth commodity. The bandwidth trading engine enables individual buyers to go to a trading company or to directly approach an enabling entity, a carrier, or any other selling entity such as a trading company or another individual, and purchase or sell bandwidth to that entity.

The enabling companies will be able to establish relationships with various bandwidth selling entities and connect their pooling points accordingly. The enabling companies can post all, or as much information about the availability of bandwidth through the enabling company. The bandwidth trading engine allows the entities to post and filter information on a global basis, and entity basis, an individual basis, a data parameter basis, or on any of a variety of other criteria or combinations thereof. The core engine operates as a central data warehouse for facilitating the trading of the bandwidth commodity and thus creates a bandwidth commodity exchange.

Thus, the present invention provides a system and a method to implement a three sectored business model that facilitates the trading of bandwidth as a commodity. One sector includes resource entities that generate the resource or commodity to be traded—bandwidth. Another sector includes bandwidth enabling entities that neutrally provide a pool of bandwidth that can be obtained from a variety of resource entities in a competitive manner. The last sector includes trading companies that interface with consumer entities or traders and facilitate the trading of the bandwidth based on the availability of the bandwidth from one or more bandwidth enabling companies. A core engine operates as the central controller and data exchange source for facilitating the execution of trades, provisioning of connections, and monitoring of the network.

What is claimed is:

1. A core engine for enabling bandwidth-trading among a plurality of entities, the core engine comprising:
a seller interface
a buyer interface;
a database;
a processing unit which, in response to executing the steps of a program module, is operative to:
receive data representing a particular bandwidth-commodity, the data identifying a bandwidth capacity, a first end point and a second end point, and being received from a bandwidth selling entity by means of the seller interface;
store the data representing the particular bandwidth-commodity into the database;
receive a bandwidth purchase request, the bandwidth purchase request identifying a desired bandwidth capacity between said first end point and said second end point, and being received from a bandwidth buying entity by means of the buyer interface; and
if the bandwidth capacity of the bandwidth-commodity is sufficient to meet the desired bandwidth capacity of the bandwidth purchase request, execute a trade in which the ownership of the desired bandwidth capacity between said first end point and said second end point will be transferred to the bandwidth buying entity.

2. A core engine for enabling bandwidth-trading among a plurality of entities, the core engine comprising:
a seller interface
a buyer interface;
a database;
a processing unit which, in response to executing the steps of a program module, is operative to:
receive data representing a plurality of bandwidth-commodities, for each of the plurality of bandwidth-commodities, the data identifying a bandwidth capacity, two of a plurality of end points, a period of time, and being received from one or more bandwidth selling entities by means of the seller interface;
store the data representing the plurality of bandwidth-commodities into the database;
receive a bandwidth purchase request, the bandwidth purchase request identifying a desired bandwidth capacity between a first end point and a second end point for a desired time period and being received from a bandwidth buying entity by means of the buyer interface;
search the database to identify a compatible bandwidth-commodity of the plurality of bandwidth-commodities that meets the desired bandwidth capacity between the first end point and the second end point for the desired time period; and
upon identifying a compatible bandwidth-commodity, execute a trade in which the ownership of the compatible bandwidth-commodity is transferred to the bandwidth buying entity.

3. The system of claim 2, further comprising a provisioning interface and prior to the commencement of the desired time period, the processing unit is further operative to send provisioning information via the provisioning interface to the facilities associated with the compatible bandwidth-commodity, the provisioning information being effective, when received by the facilities, to instruct the facilities to connect the first end point and the second end point in accordance with the compatible bandwidth-commodity.

4. The system of claim 3, further comprising a monitoring interface and during the desired time period, the processing unit is further operative to monitor the connection between the first end point and the second end point.

5. The system of claim 2, wherein the data representing a plurality of bandwidth-commodities includes pricing information for each of the plurality of bandwidth-commodities, the bandwidth purchase request includes a desired price, the processing unit being operative to search the database to identify a compatible bandwidth-commodity by further identifying a compatible bandwidth-commodity that satisfies the desired price requirements.

6. The system of claim 5, further comprising a billing interface and, prior to executing the trade the processing unit is operative to receive billing information from the bandwidth buying entity by means of the buying interface and, the processing unit is operative to execute the trade by sending the billing information over the billing interface to a billing entity.

7. The system of claim 2, further comprising a inventory interface and the processing unit being further operative to store the data representing a plurality of bandwidth-commodities within a storage device accessible through the inventory interface.

8. The system of claim 2, further comprising a data manager and the processing unit being further operative to maintain a database of information pertaining to bandwidth-commodities that have been traded, are available for trading, and the dates at which a bandwidth-commodity will become available for trading.

9. The system of claim 2, further comprising a feedback capability and the processing unit being further operative to provide feedback information via the buyer interface and the seller interface, the feedback information pertaining to status information regarding the trade.

10. A system for enabling bandwidth-trading among a plurality of entities, the system comprising:
a resource entity interface;
a trading entity interface;
a database;
a processing unit which, in response to executing the steps of a program module, is operative to:
receive data representing a plurality of bandwidth-commodities, the data being received from one or more bandwidth resource entities by means of the resource entity interface;
store the data representing the plurality of bandwidth-commodities into the database;
receive a bandwidth purchase request from a trading entity by means of the trading entity interface; and
search the database to identify a compatible bandwidth-commodity of the plurality of bandwidth-commodities that satisfies the bandwidth purchase request.

11. The system of claim 10, further comprising a buyer entity interface and, wherein upon identifying a compatible bandwidth-commodity, the processing unit is further operative to execute a trade in which the ownership of the compatible bandwidth-commodity is transferred to the buying entity.

12. The system of claim 10, wherein the trading entities interact with one or more buying entities and formulate the bandwidth purchase request based on needs of the buying entities and wherein upon identifying a compatible bandwidth-commodity, the processing unit is further operative to execute a trade in which the ownership of the compatible bandwidth-commodity is transferred to the buying entity.

13. The system of claim 10, wherein the data representing a plurality of bandwidth-commodities identifies a bandwidth capacity, two of a plurality of end points, and a period of time for each bandwidth-commodity of the plurality of bandwidth-commodities.

14. The system of claim 10, further comprising an enabling entity interface, and wherein an enabling entity is able to access the data representing a plurality of bandwidth-commodities via the enabling entity interface and is operative to create a neutral pooling point of bandwidth-commodities from various resource entities.

15. The system of claim 10, further comprising an enabling entity interface, and wherein an enabling entity is able to access the data representing a plurality of bandwidth-commodities commodities via the enabling entity interface and directly from a resource entity, and is operative to create a neutral pooling point of bandwidth-commodities from various resource entities.

16. The system of claim 14, wherein the enabling entity maintains information regarding the source of the bandwidth-commodity.

17. The system of claim 14, wherein the enabling entity maintains information regarding the buyer of a particular bandwidth-commodity.

18. The system of claim 14, wherein the enabling entity maintains information regarding connection information necessary to utilize a particular bandwidth-commodity.

19. The system of claim 14, wherein the enabling entity maintains information regarding a schedule for activating and deactivating the bandwidth-commodity.

20. The system of claim 10, wherein the bandwidth purchase request identifies a desired bandwidth capacity between a first end point and a second end point for a desired time period.

21. The system of claim 10, wherein the bandwidth purchase request identifies a desired bandwidth capacity between a first end point and a second end point.

22. A system for enabling commodity-trading among a plurality of entities, the system comprising:
a resource entity interface;
an enabling entity interface;
a trading entity interface;
a database;
a processing unit which, in response to executing the steps of a program module, is operative to:
receive data representing a plurality of commodities, the data being received from one or more resource entities by means of the resource entity interface;
share the data representing the plurality of commodities with an enabling entity by means of the enabling entity interface;
receive a purchase request from a trading entity by means of the trading entity interface; and
provide the purchase request to an enabling entity by means of the enabling entity interface; and
each enabling entity being operative interface with one or more resource entities and the processing unit to accumulate information regarding the commodities and to serve as a neutral pooling point for the commodities; and
in response to receiving a purchase request, being operative to determine if a commodity is available to satisfy the purchase request.

23. A method for trading bandwidth as a commodity, the method comprising the steps of:
receiving data representing a plurality of bandwidth-commodities from one or more resource entities;
receiving a request for a bandwidth-commodity trade from a buying entity;
if the request is for a commodity purchase, searching the data representing the plurality of bandwidth-commodities to identify a particular bandwidth-commodity that satisfies the purchase and initiate the execution of the purchase; and
if the request is for a commodity sale, searching the data representing the plurality of bandwidth-commodities to identify if there is a need for the commodity and initiate the execution of the sale.

24. The method of claim 23, wherein if the request is for a commodity purchase, further comprising the step of initiating the provisioning of a connection for the bandwidth-commodity.

25. The method of claim 24, further comprising the step of monitoring the connection to identify performance monitoring.

26. The method of claim 24, wherein after the connection is established, further comprising the step of notifying the resource entity and the buying entity that the connection has been established.

27. The method of claim 24, wherein the request for a bandwidth-commodity trade from a buying entity may be received through a trading entity.

28. The method of claim 27, wherein after the connection is established, further comprising the step of notifying the resource entity, the buying entity and the trading entity that the connection has been established.

29. The method of claim 28, wherein a billing entity is used to perform the monetary transfer to cover the bandwidth-commodity trade, further comprising the step of notifying the billing entity of the commodity purchase and the parties involved.

30. The method of claim 29, wherein after the connection is established, further comprising the step of notifying the resource entity, the buying entity, the trading entity and the billing entity that the connection has been established.

31. The method of claim 23, wherein if the request is for a commodity purchase, further comprising the step of obtaining the information necessary to provision a connection for the bandwidth and passing this information to an enabling entity for provisioning at a later date.

32. The method of claim 23, wherein if the request if for a commodity purchase, further comprising the step of obtaining the information necessary to provision a connection for the bandwidth and passing this information to a trading entity for provisioning at a later date.

33. A core engine for enabling bandwidth-trading among a plurality of entities, the core engine comprising:
a seller interface
a buyer interface;
a database;
a processing unit which, in response to executing the steps of a program module, is operative to:
receive data representing a particular bandwidth-commodity, the data identifying a bandwidth capacity, a first end point and a second end point, and being received from a bandwidth selling entity by means of the seller interface;
store the data representing the particular bandwidth-commodity into the database;
receive a bandwidth sell request, the bandwidth sell request identifying a bandwidth capacity between two end points and being received from a bandwidth buying entity by means of the buyer interface; and
execute a trade and update the database.
